(19) United States
(12) Patent Application Publication
(10) Pub. No.: US 2017/0154604 A1
(43) Pub. Date: Jun. 1, 2017

(54) METHOD AND APPARATUS FOR ADJUSTING LUMINANCE

(71) Applicant: XIAOMI INC., Beijing (CN)

(72) Inventors: Weiguang JIA, Beijing (CN); Tian REN, Beijing (CN); Enxing HOU, Beijing (CN)

(73) Assignee: XIAOMI INC., Beijing (CN)

(21) Appl. No.: 15/293,047

(22) Filed: Oct. 13, 2016

(30) Foreign Application Priority Data
Dec. 1, 2015 (CN) 201510867032.6

(51) Int. Cl. G09G 5/10; H05B 37/02

(52) U.S. Cl. CPC G09G 5/10; H05B 37/0218; H05B 37/0272; G09G 2380/14; G09G 2320/066; G09G 2320/0626; G09G 2354/00; G09G 2370/16

(57) ABSTRACT

A method and an apparatus are provided for adjusting luminance. The method includes: in response to receiving a first state instruction instructing a terminal to enter a reading mode, acquiring a preset ambient brightness corresponding to the reading mode, acquiring a device identification of a smart illuminating device in an environment where the terminal is located, and adjusting a luminance of the smart illuminating device corresponding to the device identification, based on the preset ambient brightness.

### CROSS REFERENCE TO RELATED APPLICATION

This application is based on and claims priority of the Chinese Patent Application No. 201510867032.6, filed on Dec. 1, 2015, which is incorporated herein by reference in its entirety.

### TECHNICAL FIELD

The present disclosure is related to radio communication technologies, and more particularly, to a method and apparatus for adjusting luminance.

### BACKGROUND

Nowadays, with the popularization of smart phones and tablets, more and more users love reading using electronic devices. However, when users read using electronic devices under indoor light which is too dark or bright, their eyesight may be harmed.

### SUMMARY

The present disclosure provides a method and an apparatus for adjusting luminance.

According to a first aspect of embodiments of the present disclosure, a method for adjusting luminance is provided. The method may include: in response to receiving a first state instruction instructing a terminal to enter a reading mode, acquiring a preset ambient brightness corresponding to the reading mode, acquiring a device identification of a smart illuminating device in an environment where the terminal is located, and adjusting a luminance of the smart illuminating device corresponding to the device identification, based on the preset ambient brightness.

According to a second aspect of the embodiments of the present disclosure, an apparatus for adjusting luminance adjusting is provided. The apparatus may include: a first acquiring module configured to, in response to receiving a first state instruction instructing a terminal to enter a reading mode, acquire a preset ambient brightness corresponding to the reading mode; a second acquiring module configured to acquire a device identification of a smart illuminating device in an environment where the terminal is located; and a first adjusting module configured to adjust a luminance of the smart illuminating device corresponding to the device identification acquired by the second acquiring module, based on the preset ambient brightness acquired by the first acquiring module.

According to a third aspect of the embodiments of the present disclosure, an apparatus for adjusting luminance is provided. The apparatus may include a processor, and a memory storing instructions executable by the processor. The processor may be configured to: in response to receiving a first state instruction instructing a terminal to enter a reading mode, acquire a preset ambient brightness corresponding to the reading mode, acquire a device identification of a smart illuminating device in an environment where the terminal is located, and adjust a luminance of the smart illuminating device corresponding to the device identification, based on the preset ambient brightness.

According to a fourth aspect of the embodiments of the present disclosure, a non-transitory computer-readable storage medium having stored instructions for adjusting luminance. The instructions, when executed by a processor of a mobile terminal, may cause the mobile terminal to: in response to receiving a first state instruction instructing a terminal to enter a reading mode, acquire a preset ambient brightness corresponding to the reading mode, acquire a device identification of a smart illuminating device in an environment where the terminal is located, and adjust a luminance of the smart illuminating device corresponding to the device identification, based on the preset ambient brightness.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for adjusting luminance according to an embodiment;

FIG. 2 is a flow chart showing a method for adjusting luminance according to another embodiment;

FIG. 3 is a flow chart showing a method for adjusting luminance according to yet another embodiment;

FIG. 4 is a flow chart showing a method for adjusting luminance according to still another embodiment;

FIG. 5 is a flow chart showing a method for adjusting luminance according to still yet another embodiment;

FIG. 6 is a flow chart showing a method for adjusting luminance according to a further embodiment;

FIG. 7 is a flow chart showing a method for adjusting luminance according to yet a further embodiment;

FIG. 8 is a flow chart showing a method for adjusting luminance according to still a further embodiment;

FIG. 9 is a block diagram of an apparatus for adjusting luminance according to an embodiment;

FIG. 10 is a block diagram of a first adjusting module according to an embodiment;

FIG. 11 is a block diagram of a first adjusting module according to another embodiment;

FIG. 12 is a block diagram of a first adjusting module according to yet another embodiment;

FIG. 13 is a block diagram of an apparatus for adjusting luminance according to another embodiment;

FIG. 14 is a block diagram of an apparatus for adjusting luminance according to yet another embodiment;

FIG. 15 is a block diagram of an apparatus for adjusting luminance according to still another embodiment;

FIG. 16 is a block diagram of an apparatus for adjusting luminance according to still yet another embodiment; and

FIG. 17 is a block diagram of an apparatus for adjusting luminance according to a further embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present application. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise presented. The embodiments set forth in the following description of embodiments do not represent all embodiments consistent with the disclosure. Instead, they are merely examples of apparatuses and methods consistent with aspects related to the disclosure as recited in the appended claims.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The technical solutions provided by the embodiments of the present disclosure relate to a terminal and a server. The terminal or the server controls a smart illuminating device to adjust its luminance based on an ambient brightness in an environment where the terminal is located, so that indoor ambient brightness is more suitable for a user to read using an electronic device. Thus, a better reading environment can be provided and the user's eyesight can be protected.

The terminal may be any device with an electronic reading function, such as a mobile phone, a computer, a digital broadcast terminal, a messaging device, a gaming console, a tablet, a medical device, exercise equipment, a personal digital assistant, etc.

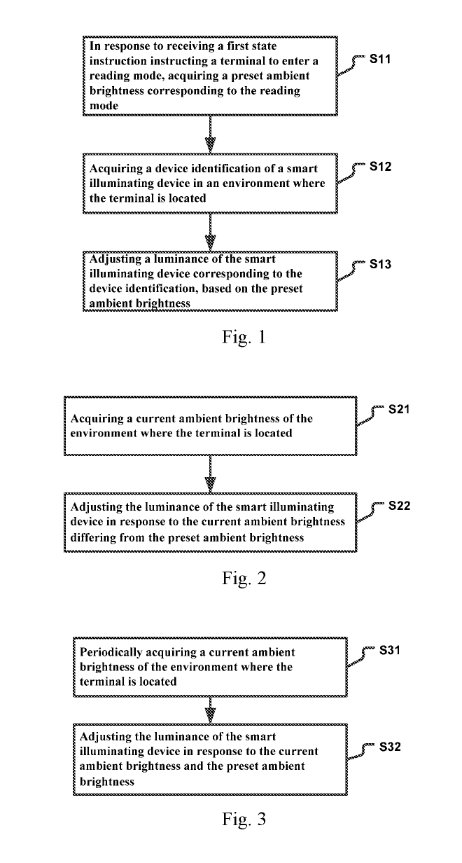

FIG. 1 is a flow chart showing a method for adjusting luminance according to an embodiment. As shown in FIG. 1, the method for adjusting luminance is used in a server or a terminal and includes the following steps.

In step S11, in response to receiving a first state instruction instructing a terminal to enter a reading mode, a preset ambient brightness corresponding to the reading mode is acquired.

In step S12, a device identification of a smart illuminating device in an environment where the terminal is located is acquired.

In step S13, a luminance of the smart illuminating device corresponding to the device identification is adjusted based on the preset ambient brightness.

In this embodiment, when a user uses reading software or a browser of a terminal for a certain duration or even longer, it is determined that the terminal is in a reading mode. Then, the adjustment of the ambient brightness is triggered. The terminal or the server acquires the preset ambient brightness for the reading mode and the device identification of the indoor smart illuminating device, and controls the smart illuminating device to adjust its luminance, so that a current ambient brightness reaches the preset ambient brightness. By doing so, a difference between the ambient brightness and a luminance of the terminal's electronic screen is reduced, so that the ambient brightness becomes suitable for the user's electronic reading and the user's eyesight can be protected.

In another embodiment, the current indoor ambient brightness is detected to determine whether the luminance of the smart illuminating device needs to be adjusted. FIG. 2 is a flow chart showing a method for adjusting luminance according to another embodiment. As shown in FIG. 2, adjusting the luminance of the smart illuminating device corresponding to the device identification based on the preset ambient brightness includes the following steps.

In step S21, a current ambient brightness of the environment where the terminal is located is acquired.

In step S22, the luminance of the smart illuminating device is adjusted in response to the current ambient brightness differing from the preset ambient brightness.

In this embodiment, if the ambient brightness is lower or higher than the preset ambient brightness, the luminance of the smart illuminating device will be adjusted, so that indoor light is not too bright or too dark but becomes suitable for the user's electronic reading and the user's eyesight can be protected.

In another embodiment, when staying in the reading mode, the terminal may periodically adjust the luminance of the smart illuminating device based on the indoor light brightness. FIG. 3 is a flow chart showing a method for adjusting luminance according to yet another embodiment. As shown in FIG. 3, adjusting the luminance of the smart illuminating device corresponding to the device identification based on the preset ambient brightness includes the following steps.

In step S31, a current ambient brightness of the environment where the terminal is located is periodically acquired.

In step S32, the luminance of the smart illuminating device is adjusted based on the current ambient brightness and the preset ambient brightness.

In this embodiment, the difference between the indoor illuminating brightness and the luminance of the terminal's electronic screen is kept small while the user is reading, so that the indoor illuminating brightness become suitable for the user's electronic reading all the time and the user's eyesight can thus be protected.

The current ambient brightness may be acquired with different time intervals. For example, the current ambient brightness is acquired every one minute or every 5 minutes or any other pre-determined time period. The frequency to acquire the ambient brightness may vary and may depend on the amount of adjustment that is made previously. For example, a frequency to acquire the ambient brightness may be every one minute when the most current adjustment made for the smart illuminating device is over 10%. Also, the frequency to acquire the ambient brightness may be every 5 minutes when the last adjustment for the smart illuminating device is less than 5%.

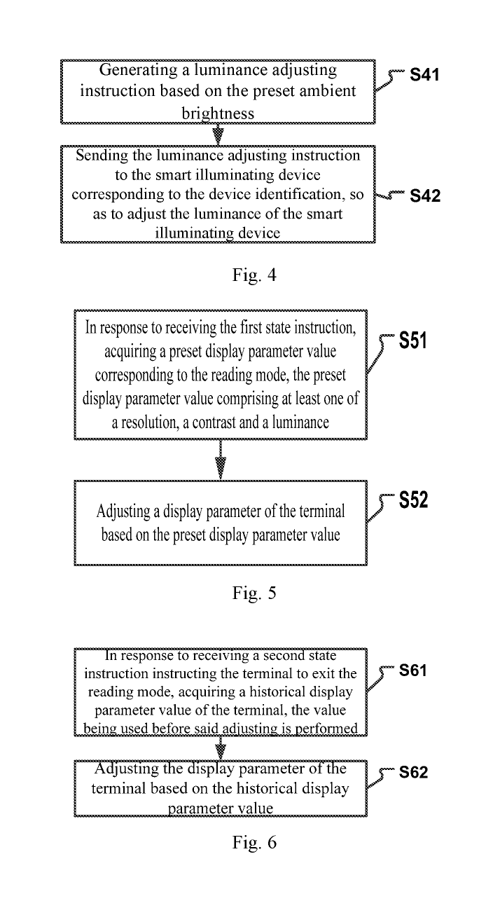

In another embodiment, the terminal or the server may send a luminance adjusting instruction to the smart illuminating device wirelessly, for example, by means of WiFi. FIG. 4 is a flow chart showing a method for adjusting luminance according to still another embodiment. As shown in FIG. 4, adjusting the luminance of the smart illuminating device corresponding to the device identification based on the preset ambient brightness includes the following steps.

In step S41, a luminance adjusting instruction is generated based on the preset ambient brightness.

In step S42, the luminance adjusting instruction is sent to the smart illuminating device corresponding to the device identification, so as to adjust the luminance of the smart illuminating device.

In this embodiment, the luminance of the smart illuminating device is adjusted by the luminance adjusting instruction, so that indoor light is not too bright or too dark but is suitable for the user's electronic reading and the user's eyesight can be protected.

In another embodiment, if the luminance adjusting instruction is generated by the terminal, then sending the luminance adjusting instruction to the smart illuminating device corresponding to the device identification includes: sending the luminance adjusting instruction and the device identification to a network, where the luminance adjusting instruction is forwarded to the smart illuminating device corresponding to the device identification via the network.

In another embodiment, if the luminance of the smart illuminating device is adjusted by the terminal, the method further includes: generating the first state instruction in response to a time period during which the terminal runs a preset application being longer than or equal to a preset duration.

In addition to adjusting the luminance of the smart illuminating device, the terminal may also adjust its display parameter so as to better protect the user's eyesight. FIG. 5 is a flow chart showing a method for adjusting luminance according to still yet another embodiment. As shown in FIG. 5, the method further includes the following steps.

In step S51, in response to receiving the first state instruction, a preset display parameter value corresponding to the reading mode is acquired, the preset display parameter value including at least one of: a resolution, a contrast and a luminance.

In step S52, a display parameter of the terminal is adjusted based on the preset display parameter value.

In this embodiment, when the terminal is in the reading mode, it also adjusts its display parameter, such as a resolution, a contrast, a luminance, etc., so that the burden on the user's eyes adapting themselves for reading on the electronic screen can be reduced and the user's eyesight can be protected.

The adjustment made may be according to correlations among displayer parameters. For example, when the resolution and the contrast are small, the luminance may be adjusted to be high. On the other hand, when the resolution and the contrast are big, the luminance may be adjusted to be low.

In another embodiment, when the terminal exits the reading mode, the terminal may revert its display parameter or display parameters to the previous setting. FIG. 6 is a flow chart showing a method for adjusting luminance according to yet another embodiment. As shown in FIG. 6, the method further includes the following steps.

In step S61, in response to receiving a second state instruction instructing the terminal to exit the reading mode, a historical display parameter value of the terminal is acquired, where the historical display parameter value may be display parameter value that is used before adjusting the display parameter of the terminal.

In step S62, the display parameter of the terminal is adjusted based on the historical display parameter value.

In this embodiment, the terminal stores the historical display parameter value which is used before the terminal enters the reading mode, and reverts to the previous display setting based on the stored historical display parameter value when the terminal exits the reading mode, so that the user can use other applications of the terminal conveniently, thereby improving the user experience.

In the following, it is described in detail how a terminal controls a luminance of a smart illuminating device.

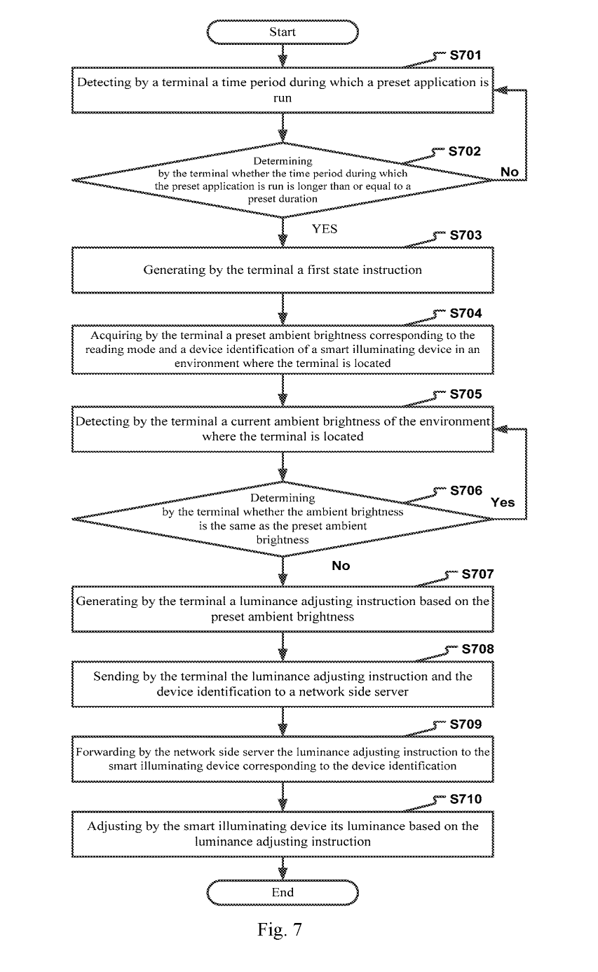

FIG. 7 is a flow chart showing a method for adjusting luminance according to yet a further embodiment. As shown in FIG. 7, the method includes the following steps.

In S701, a terminal detects a time period during which a preset application is run.

In S702, the terminal determines whether the time period during which the preset application is run is longer than or equal to a preset duration. If so, step S703 is executed; if not, step S701 is executed.

In S703, the terminal generates a first state instruction.

In S704, the terminal acquires a preset ambient brightness corresponding to the reading mode and a device identification of a smart illuminating device in an environment where the terminal is located.

In S705, the terminal detects a current ambient brightness of the environment where the terminal is located.

In S706, the terminal determines whether the current ambient brightness is the same as the preset ambient brightness. If so, S705 is executed; if not, step S707 is executed.

In S707, the terminal generates a luminance adjusting instruction based on the preset ambient brightness.

In S708, the terminal sends the luminance adjusting instruction and the device identification to a network side server.

In S709, the network side server forwards the luminance adjusting instruction to the smart illuminating device corresponding to the device identification.

In S710, the smart illuminating device adjusts its luminance based on the luminance adjusting instruction.

In this embodiment, the terminal acquires the preset ambient brightness for the reading mode and the device identification of the indoor smart illuminating device, and controls the smart illuminating device to adjust its luminance, so that the current ambient brightness reaches the preset ambient brightness. By doing so, a difference between the ambient brightness and a luminance of the terminal's electronic screen is reduced, so that the ambient brightness becomes suitable for the user's electronic reading and the user's eyesight can be protected.

In the following, it is described in detail how a network side server controls a luminance of a smart illuminating device.

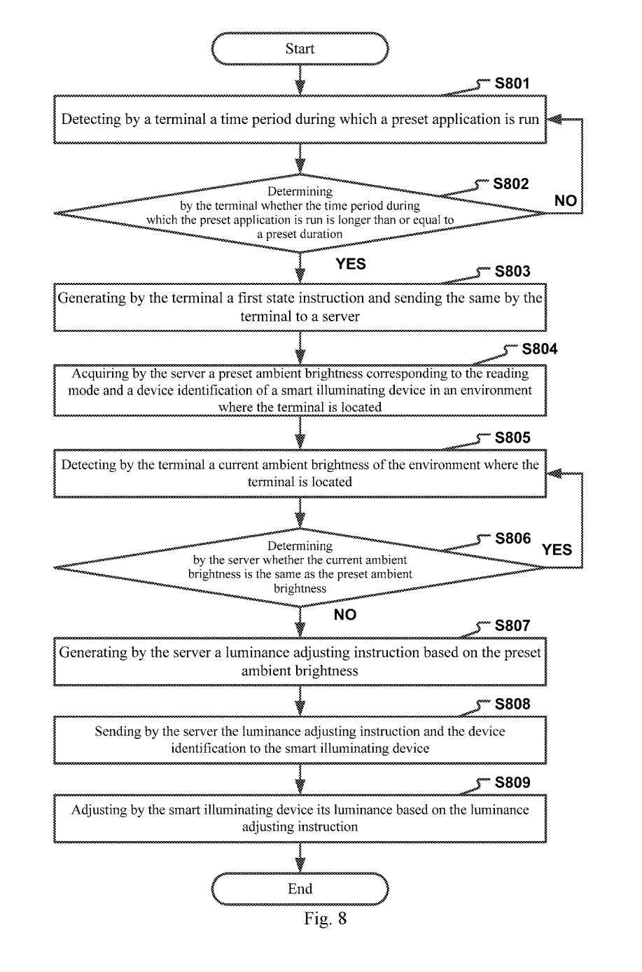

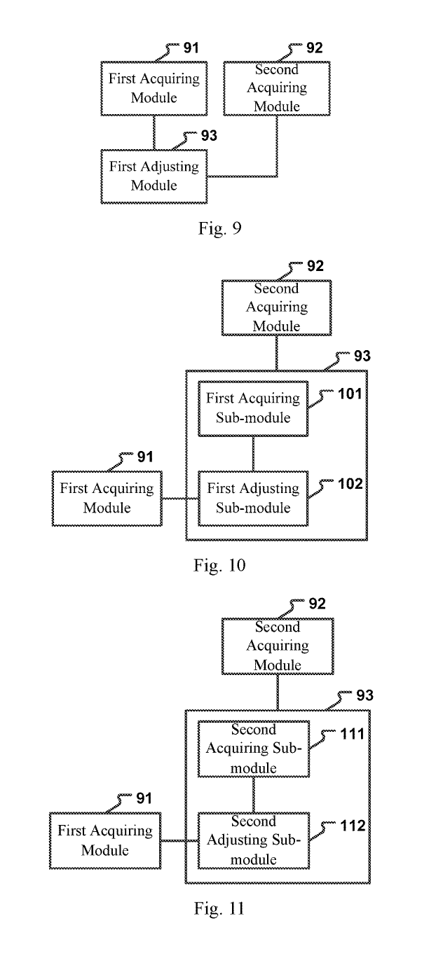

FIG. 8 is a flow chart showing a method for adjusting luminance according to yet another embodiment. As shown in FIG. 8, the method includes the following steps.

In S801, a terminal detects a time period during which a preset application is run.

In S802, the terminal determines whether the time period during which the preset application is run is longer than or equal to a preset duration. If so, S803 is executed; if not, S801 is executed.

In S803, the terminal generates a first state instruction and sends the same to a server.

In S804, the server acquires a preset ambient brightness corresponding to the reading mode and a device identification of a smart illuminating device in an environment where the terminal is located.

In S805, the terminal detects a current ambient brightness of the environment where the terminal is located, and sends the same to the server periodically.

In S806, the server determines whether the current ambient brightness is the same as the preset ambient brightness. If so, step S805 is executed; if not, step S807 is executed.

In S807, the server generates a luminance adjusting instruction based on the preset ambient brightness.

In S808, the server sends the luminance adjusting instruction and the device identification to the smart illuminating device.

In S809, the smart illuminating device adjusts its luminance based on the luminance adjusting instruction.

In this embodiment, the server acquires the preset ambient brightness for the reading mode and the device identification of the indoor smart illuminating device, and controls the smart illuminating device to adjust its luminance, so that the current ambient brightness reaches the preset ambient brightness. By doing so, a difference between the ambient brightness and a luminance of the terminal's electronic screen is reduced, so that the ambient brightness becomes suitable for the user's electronic reading and the user's eyesight can be protected.

The preset ambient brightness may be a plurality of sets for the ambient brightness. For example, each reader may have his or her own preset ambient brightness. The old people may have different preset ambient brightness from young people because the old people and young people have different visions.

In S804, the terminal may send its positional information to the server, so that the server can acquire the device identification of the smart illuminating device corresponding to the positional information. Alternatively, the terminal may obtain and send the detected device identification of the smart illuminating device in the environment to the server.

The followings describe apparatus embodiments of this disclosure, which may be used to perform the method embodiments of this disclosure.

FIG. 9 is a block diagram of an apparatus for adjusting luminance according to an embodiment. The apparatus may be implemented as an electronic device or part of it in the form of software, hardware or a combination thereof. As shown in FIG. 9, the apparatus for adjusting luminance includes the following components.

A first acquiring module 91 is configured to, in response to receiving a first state instruction instructing a terminal to enter a reading mode, acquire a preset ambient brightness corresponding to the reading mode.

A second acquiring module 92 is configured to acquire a device identification of a smart illuminating device in an environment where the terminal is located.

A first adjusting module 93 is configured to adjust a luminance of the smart illuminating device corresponding to the device identification acquired by the second acquiring module based on the preset ambient brightness acquired by the first acquiring module.

In this embodiment, when a user uses reading software or a browser of the terminal, if the user uses the software or browser for a certain period of time or longer, it is determined that the terminal is in the reading mode. Then, the adjustment of the ambient brightness is triggered. The terminal or a server acquires the preset ambient brightness for the reading mode and the device identification of the indoor smart illuminating device, and controls the smart illuminating device to adjust its luminance, so that a current ambient brightness reaches the preset ambient brightness. By doing so, a difference between the ambient brightness and a luminance of the terminal's electronic screen is reduced, so that the ambient brightness becomes suitable for the user's electronic reading and the user's eyesight can be protected.

In another embodiment, the current indoor ambient brightness is detected to determine whether the luminance of the smart illuminating device needs to be adjusted. FIG. 10 is a block diagram of a first adjusting module according to an embodiment. As shown in FIG. 10, the first adjusting module 93 includes the following components.

A first acquiring sub-module 101 is configured to acquire a current ambient brightness of the environment where the terminal is located.

A first adjusting sub-module 102 is configured to adjust the luminance of the smart illuminating device in response to the ambient brightness acquired by the first acquiring sub-module 101 differing from the preset ambient brightness acquired by the first acquiring module 91.

In this embodiment, if the current ambient brightness is lower or higher than the preset ambient brightness, the luminance of the smart illuminating device is adjusted, so that indoor light is not too bright or too dark but is suitable for the user's electronic reading and the user's eyesight can be protected.

In another embodiment, when staying in the reading mode, the terminal periodically adjusts the luminance of the smart illuminating device based on the ambient brightness. FIG. 11 is a block diagram of a first adjusting module according to another embodiment. As shown in FIG. 11, the first adjusting module 93 includes the following components.

A second acquiring sub-module 111 is configured to periodically acquire a current ambient brightness of the environment where the terminal is located.

A second adjusting sub-module 112 is configured to adjust the luminance of the smart illuminating device based on the current ambient brightness acquired by the second acquiring sub-module 111 and the preset ambient brightness acquired by the first acquiring module 91.

In this embodiment, the difference between the indoor illuminating brightness and the luminance of the terminal's electronic screen is kept small during the user's reading, so that the indoor illuminating brightness is suitable for the user's electronic reading all the time and the user's eyesight can thus be protected.

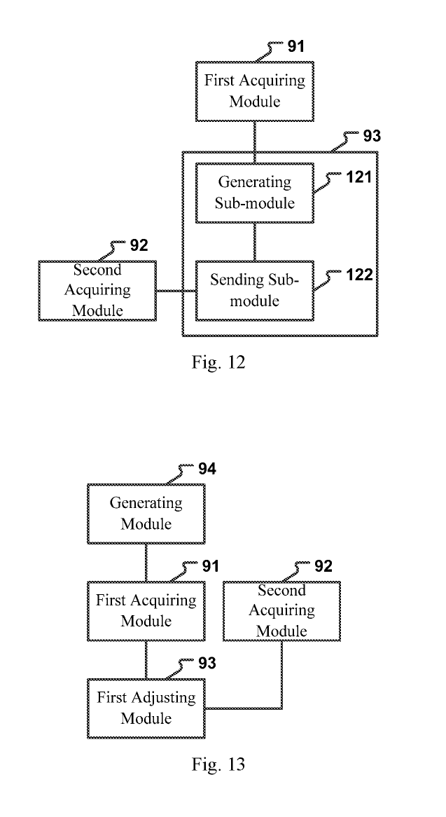

In another embodiment, the terminal or the server may send a luminance adjusting instruction to the smart illuminating device wireless, for example, by means of WiFi. FIG. 12 is a block diagram of a first adjusting module according to yet another embodiment. As shown in FIG. 12, the first adjusting module 93 includes the following components.

A generating sub-module 121 is configured to generate a luminance adjusting instruction based on the preset ambient brightness acquired by the first acquiring module.

A sending sub-module 122 is configured to send the luminance adjusting instruction generated by the generating sub-module 121 to the smart illuminating device corresponding to the device identification, so as to adjust the luminance of the smart illuminating device.

In this embodiment, the luminance of the smart illuminating device is adjusted by the luminance adjusting instruction, so that indoor light is not too bright or too dark but more suitable for the user's reading and the user's eyesight can be protected.

In another embodiment, if the luminance adjusting instruction is generated by the terminal, the luminance adjusting instruction is sent to the smart illuminating device corresponding to the device identification. Optionally, the sending sub-module 122 is configured to send the luminance adjusting instruction generated by the generating sub-module 121 and the device identification acquired by the second acquiring module 92 to a network, where the luminance adjusting instruction is forwarded to the smart illuminating device corresponding to the device identification via the network.

In this embodiment, the first adjusting module 93 may include all of the first acquiring sub-module 101, the first adjusting sub-module 102, the second acquiring sub-module 111, the second adjusting sub-module 112, the generating sub-module 121 and the sending sub-module 122.

In another embodiment, if the luminance of the smart illuminating device is adjusted by the terminal, the apparatus further includes, as shown in FIG. 13 which is a block diagram of an apparatus for adjusting luminance according to the embodiment, a generating module 94 configured to generate the first state instruction in response to a time period during which the terminal runs a preset application being longer than or equal to a preset duration.

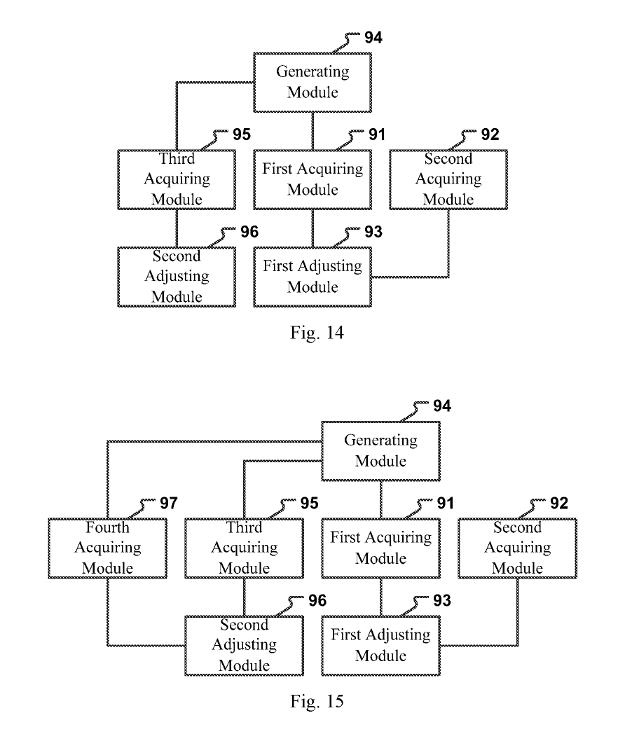

In addition to adjusting the luminance of the smart illuminating device, the terminal may also adjust its display parameter so as to better protect the user's eyesight. FIG. 14 is a block diagram of an apparatus for adjusting luminance according to yet another embodiment. As shown in FIG. 14, the apparatus further includes the following components.

A third acquiring module 95 is configured to, in response to receiving the first state instruction generated by the generating module, acquire a preset display parameter value corresponding to the reading mode, the preset display parameter value including at least one of: a resolution, a contrast and a luminance.

A second adjusting module 96 is configured to adjust a display parameter of the terminal based on the preset display parameter value acquired by the third acquiring module 95.

In this embodiment, when the terminal is in the reading mode, it also adjusts its display parameter, such as a resolution, a contrast, a luminance, etc., so that the burden on the user's eyes adapting themselves for reading on the electronic screen can be reduced and the user's eyesight can be protected.

In another embodiment, when the terminal exits the reading mode, the terminal may revert its display parameter to the previous setting. FIG. 15 is a block diagram of an apparatus for adjusting luminance according to yet another embodiment. As shown in FIG. 15, the apparatus further includes the following components.

A fourth acquiring module 97 is configured to, in response to receiving a second state instruction instructing the terminal to exit the reading mode, acquire a historical display parameter value of the terminal, which is the value being used before adjusting the display parameter of the terminal.

The second adjusting module 96 is further configured to adjust the display parameter of the terminal based on the historical display parameter value acquired by the fourth acquiring module 97.

In this embodiment, the terminal stores the historical display parameter value which is used before the terminal enters the reading mode, and reverts to the previous display setting based on the stored historical display parameter value when the terminal exits the reading mode, so that the user can use other applications of the terminal conveniently, thereby improving the user experience.

This disclosure also provides an apparatus for adjusting luminance, including a processor and a memory storing instructions executable by the processor. The processor is configured to: in response to receiving a first state instruction instructing a terminal to enter a reading mode, acquire a preset ambient brightness corresponding to the reading mode, acquire a device identification of a smart illuminating device in an environment where the terminal is located, and adjust a luminance of the smart illuminating device corresponding to the device identification, based on the preset ambient brightness.

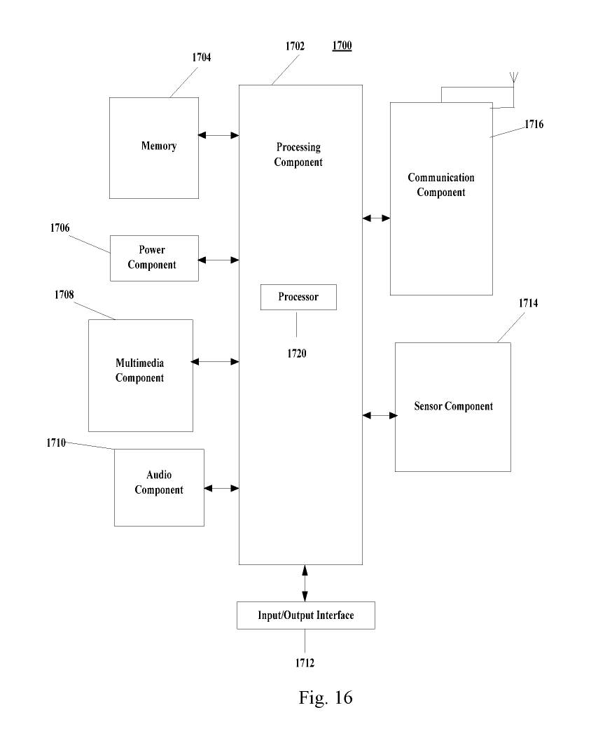

FIG. 16 is a block diagram of an apparatus for adjusting luminance according to yet another embodiment. The apparatus may be applied to a terminal. For example, the apparatus 1700 may be a camera, a sound recording device, mobile phone, a computer, a digital broadcast terminal, a messaging device, a gaming console, a tablet, a medical device, exercise equipment, a personal digital assistant or the like.

The apparatus 1700 may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 typically controls overall operations of the apparatus 1700, such as the operations associated with display, telephone calls, data communications, camera operations, and recording operations. The processing component 1702 may include one or more processors 1720 to execute instructions to perform all or part of the steps in the above described methods. Moreover, the processing component 1702 may include one or more modules which facilitate the interaction between the processing component 1702 and other components. For instance, the processing component 1702 may include a multimedia module to facilitate the interaction between the multimedia component 1708 and the processing component 1702.

The memory 1704 is configured to store various types of data to support the operation of the apparatus 1700. Examples of such data include instructions for any applications or methods operated on the apparatus 1700, contact data, phonebook data, messages, pictures, video, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the apparatus 1700. The power component 1706 may include a power management system, one or more power sources, and any other components associated with the generation, management, and distribution of power in the apparatus 1700.

The multimedia component 1708 includes a screen providing an output interface between the apparatus 1700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1708 includes a front camera and/or a rear camera. The front camera and the rear camera may receive an external multimedia datum while the apparatus 1700 is in an operation mode, such as a photographing mode or a video mode. Each of the front camera and the rear camera may be a fixed optical lens system or have focus and optical zoom capability.

The audio component 1710 is configured to output and/or input audio signals. For example, the audio component 1710 includes a microphone (“MIC”) configured to receive an external audio signal when the apparatus 1700 is in an operation mode, such as a call mode, a recording mode, and a voice recognition mode. The received audio signal may be further stored in the memory 1704 or transmitted via the communication component 1716. In some embodiments, the audio component 1710 further includes a speaker to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors to provide status assessments of various aspects of the apparatus 1700. For instance, the sensor component 1714 may detect an open/closed status of the apparatus 1700, relative positioning of components, e.g., the display and the keypad, of the apparatus 1700, a change in position of the apparatus 1700 or a component of the apparatus 1700, a presence or absence of user contact with the apparatus 1700, an orientation or an acceleration/deceleration of the apparatus 1700, and a change in temperature of the apparatus 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an accelerometer sensor, a gyroscope sensor, a magnetic sensor, a pressure sensor, or a temperature sensor.

The communication component 1716 is configured to facilitate communication, wired or wirelessly, between the apparatus 1700 and other devices. The apparatus 1700 can access a wireless network based on a communication standard, such as WiFi, 2G or 3G; or a combination thereof. In one embodiment, the communication component 1716 receives a broadcast signal or broadcast associated information from an external broadcast management system via a broadcast channel. In one embodiment, the communication component 1716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an embodiment, there is also provided a non-transitory computer readable storage medium including instructions, such as included in the memory 1704, executable by the processor 1720 in the apparatus 1700, for performing the above-described methods. For example, the non-transitory computer readable storage medium may be a ROM, a RAM, a CD-ROM, a magnetic tape, a floppy disc, an optical data storage device, and the like.

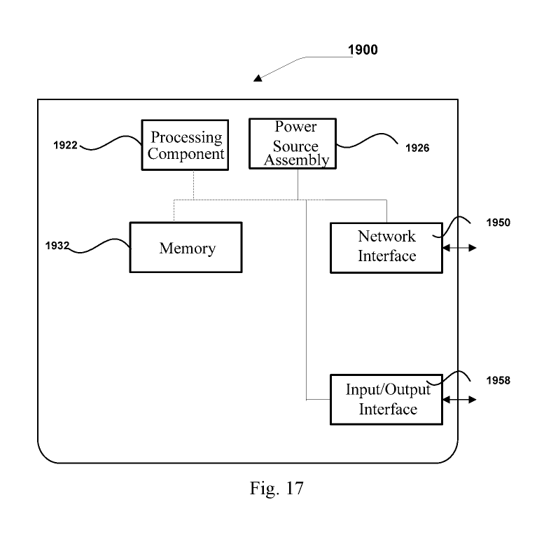

FIG. 17 is a block diagram of an apparatus for adjusting luminance according to yet another embodiment. For example, the smart device grouping apparatus 1900 may be provided as a server. The apparatus 1900 includes a processing component 1922 which further includes one or more processors, and memory resources represented by a memory 1932 for storing instructions executable by the processing component 1922 such as applications. The applications stored in the memory 1932 may include one or more modules, each corresponding to a set of instructions. The processing component 1922 is configured to execute instructions so as to perform the above method.

The apparatus 1900 may also include a power source assembly 1926 which is configured to execute power management for the apparatus 1900, a wired or wireless network interface 1950 which is configured to connect the apparatus 1900 to a network, and an input/output (I/O) interface 1958. The apparatus 1900 can operate the operation system stored in the memory 1932, for example, Windows Server™, Mac OS X™, Unix™, Linux™, Free BSD™ or the like.

A non-transitory computer-readable storage medium having stored therein instructions for adjusting luminance is provided. The instructions, when executed by a processor of the apparatus 1700 or 1900, may cause the apparatus 1700 or 1900 to: in response to receiving a first state instruction instructing a terminal to enter a reading mode, acquire a preset ambient brightness corresponding to the reading mode, acquire a device identification of a smart illuminating device in an environment where the terminal is located, and adjust a luminance of the smart illuminating device corresponding to the device identification, based on the preset ambient brightness.

Optionally, the instructions to adjust the luminance of the smart illuminating device may further cause the processor to acquire a current ambient brightness of the environment where the terminal is located and adjusting the luminance of the smart illuminating device in response to the current ambient brightness differing from the preset ambient brightness.

Optionally, the instructions to adjust the luminance of the smart illuminating device may further cause the processor to periodically acquire a current ambient brightness of the environment where the terminal is located and adjusting the luminance of the smart illuminating device based on the current ambient brightness and the preset ambient brightness.

Optionally, the instructions to adjust the luminance of the smart illuminating device may further cause the processor to generate a luminance adjusting instruction based on the preset ambient brightness, and send the luminance adjusting instruction to the smart illuminating device corresponding to the device identification so as to adjust the luminance of the smart illuminating device.

Optionally, the instructions to send the luminance adjusting instruction to the smart illuminating device may further cause the processor to send the luminance adjusting instruction and the device identification to a network, where the luminance adjusting instruction is forwarded to the smart illuminating device via the network.

Optionally, the instructions may further cause the processor to generate the first state instruction in response to a time period during which the terminal runs a preset application being longer than or equal to a preset duration.

Optionally, the instructions may further cause the processor to: in response to receiving the first state instruction, acquire a preset display parameter value corresponding to the reading mode, the preset display parameter value including at least one of: a resolution, a contrast and a luminance; and adjust a display parameter of the terminal based on the preset display parameter value.

Optionally, the instructions may further cause the processor to: in response to receiving a second state instruction instructing the terminal to exit the reading mode, acquire a historical display parameter value of the terminal, the value being used before adjusting the display parameter of the terminal, and adjust the display parameter of the terminal based on the historical display parameter value.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for adjusting luminance, comprising:
in response to receiving a first state instruction instructing a terminal to enter a reading mode, acquiring a preset ambient brightness corresponding to the reading mode;
acquiring a device identification of a smart illuminating device in an environment where the terminal is located; and
adjusting a luminance of the smart illuminating device corresponding to the device identification, based on the preset ambient brightness.

2. The method of claim 1, wherein adjusting the luminance of the smart illuminating device further comprises:
acquiring a current ambient brightness of the environment where the terminal is located; and
adjusting the luminance of the smart illuminating device in response to the current ambient brightness differing from the preset ambient brightness.

3. The method of claim 1, wherein adjusting the luminance of the smart illuminating device further comprises:
periodically acquiring a current ambient brightness of the environment where the terminal is located; and
adjusting the luminance of the smart illuminating device based on the current ambient brightness and the preset ambient brightness.

4. The method of claim 1, wherein adjusting the luminance of the smart illuminating device further comprises:
generating a luminance adjusting instruction based on the preset ambient brightness, and sending the luminance adjusting instruction to the smart illuminating device corresponding to the device identification, so as to adjust the luminance of the smart illuminating device.

5. The method of claim 4, wherein sending the luminance adjusting instruction to the smart illuminating device further comprises:
sending the luminance adjusting instruction and the device identification to a network, wherein the luminance adjusting instruction is forwarded to the smart illuminating device via the network.

6. The method of claim 1, further comprising: generating the first state instruction in response to a time period during which the terminal runs a preset application being longer than or equal to a preset duration.

7. The method of claim 6, further comprising:
in response to receiving the first state instruction, acquiring a preset display parameter value corresponding to the reading mode, the preset display parameter value comprising at least one of: a resolution, a contrast and a luminance; and
adjusting a display parameter of the terminal based on the preset display parameter value.

8. The method of claim 7, further comprising:
in response to receiving a second state instruction instructing the terminal to exit the reading mode, acquiring a historical display parameter value of the terminal, the historical display parameter value being used before adjusting the display parameter of the terminal; and
adjusting the display parameter of the terminal based on the historical display parameter value.

9. An apparatus for adjusting luminance, comprising:
a processor; and
a memory storing instructions executable by the processor, wherein the processor is configured to:
in response to receiving a first state instruction instructing a terminal to enter a reading mode, acquire a preset ambient brightness corresponding to the reading mode;
acquire a device identification of a smart illuminating device in an environment where the terminal is located; and
adjust a luminance of the smart illuminating device corresponding to the device identification, based on the preset ambient brightness.

10. The apparatus of claim 9, wherein the processor is further configured to:
acquire a current ambient brightness of the environment where the terminal is located; and
adjust the luminance of the smart illuminating device in response to the current ambient brightness differing from the preset ambient brightness.

11. The apparatus of claim 9, wherein the processor is further configured to:
periodically acquire a current ambient brightness of the environment where the terminal is located; and
adjust the luminance of the smart illuminating device based on the current ambient brightness and the preset ambient brightness.

12. The apparatus of claim 9, wherein the processor is further configured to:
generate a luminance adjusting instruction based on the preset ambient brightness, and send the luminance adjusting instruction to the smart illuminating device corresponding to the device identification, so as to adjust the luminance of the smart illuminating device.

13. The apparatus of claim 12, wherein the processor is further configured to: send the luminance adjusting instruction and the device identification to a network, wherein the luminance adjusting instruction is forwarded to the smart illuminating device via the network.

14. The apparatus of claim 9, wherein the processor is further configured to: generate the first state instruction in response to a time period during which the terminal runs a preset application being longer than or equal to a preset duration.

15. The apparatus of claim 14, wherein the processor is further configured to:
in response to receiving the first state instruction, acquire a preset display parameter value corresponding to the reading mode, the preset display parameter value comprising at least one of: a resolution, a contrast and a luminance; and
adjust a display parameter of the terminal based on the preset display parameter value.

16. The apparatus of claim 15, wherein the processor is further configured to:
in response to receiving a second state instruction instructing the terminal to exit the reading mode, acquire a historical display parameter value of the terminal, the historical display parameter value being used before adjusting the display parameter of the terminal; and
adjust the display parameter of the terminal based on the historical display parameter value.

17. A non-transitory computer-readable storage medium having stored instructions therein for adjusting luminance, wherein the instructions, when executed by a processor of a mobile terminal, cause the mobile terminal to:
in response to receiving a first state instruction instructing a terminal to enter a reading mode, acquire a preset ambient brightness corresponding to the reading mode;
acquire a device identification of a smart illuminating device in an environment where the terminal is located; and
adjust a luminance of the smart illuminating device corresponding to the device identification, based on the preset ambient brightness.

18. The storage medium of claim 17, wherein the instructions to adjust the luminance of the smart illuminating device further cause the mobile terminal to:
acquire a current ambient brightness of the environment where the terminal is located; and
adjust the luminance of the smart illuminating device in response to the current ambient brightness differing from the preset ambient brightness.

19. The storage medium of claim 17, wherein the instructions to adjust the luminance of the smart illuminating device further cause the mobile terminal to:
periodically acquire a current ambient brightness of the environment where the terminal is located; and
adjust the luminance of the smart illuminating device based on the current ambient brightness and the preset ambient brightness.

20. The storage medium of claim 17, wherein the instructions to adjust the luminance of the smart illuminating device further cause the mobile terminal to:
generate a luminance adjusting instruction based on the preset ambient brightness, and send the luminance adjusting instruction to the smart illuminating device corresponding to the device identification, so as to adjust the luminance of the smart illuminating device.
